(19) United States
(12) Patent Application Publication
(10) Pub. No.: US 2013/0183087 A1
(43) Pub. Date: Jul. 18, 2013

(54) Molded Composite Threads

(71) Applicant: Greene, Tweed of Delaware, Inc., Wilmington, DE (US)

(72) Inventors: Nicolas Weibel, Prilly (CH); Samuel Stutz, Ecublens (CH); Mathieu Piccand, Pully (CH); Daniel Rougnon, Lausanne (CH)

(73) Assignee: GREENE, TWEED OF DELAWARE, INC., Wilmington, DE (US)

(21) Appl. No.: 13/742,324

(22) Filed: Jan. 15, 2013

Related U.S. Application Data
(60) Provisional application No. 61/587,396, filed on Jan. 17, 2012.

(51) Int. Cl. F16B 7/18; B29C 39/04

(52) U.S. Cl. CPC F16B 7/18; B29C 39/04
USPC 403/343; 264/314; 428/399; 428/36.92; 428/34.5

(57) ABSTRACT

Molded articles are described herein having a surface feature thereon, the articles being formed so as to include a polymeric composite material having reinforcing fibers in a polymeric matrix material. The surface feature(s) is created during heat molding of the polymeric composite material to form the article and the surface feature(s) include the polymeric matrix material and the reinforcing fibers therein. A method is also described which provides surface feature(s) to a molded article by providing a composite material as noted, placing the composite material in a mold for forming an article having a surface feature thereon, and molding the composite material using bladder inflation molding and pushing the reinforcing fibers into the surface feature of the molded article during molding using a heat molding process having a bladder inflation molding step, wherein the surface feature is created during the molding of the polymeric composite material to form the molded article and the reinforcing fibers are present in the polymeric matrix material defining the surface feature in the molded article.

### CROSS-REFERENCE TO RELATED APPLICATIONS

This application claims the benefit under 35 U.S.C. §119(e) of U.S. Provisional Patent Application No. 61/587,396, entitled, “Molded Composite Threads,” the entire disclosure of which is incorporated herein by reference.

### BACKGROUND OF THE INVENTION

1. Field of the Invention

The invention is in the field of formation of parts having intricate surface features such as threaded features and provides a new way to apply tensile, compression and/or torsional loads to composite materials to achieve improved performance in polymeric and composite components having intricate surface features.

2. Description of Related Art

Polymeric and composite materials are used in various applications to make parts and components for use in a wide variety of end applications and can be used to replace costly, heavy materials. However, in formation of such components, it can be difficult to provide them with important, intricate surface features, filled with matrix and reinforcing fibers without machining the feature(s) into the surface. One such area is in the formation of threaded features on the outside and/or inside of a polymeric or composite fastener or connector. The connection of a composite tube to a counterpart in an assembly has been a challenge in the art for many years.

In the past, parts have been formed, and then features such as threads machined into the surface of the composite part. For example, a composite can be formed into the shape of a bolt, and threading machined into the surface. Machined threads on a composite, however, can have issues in terms of the strength of the material and long-term performance. As another example, a composite can be formed into the shape of a threaded bolt through injection molding or flow molding, wherein the matrix and fibers therein fill the thread. In this case, however, fibers generally are provided in the thread in a random orientation which tends to provide sub-optimal strength for the resulting threaded composite part.

Alternatively, end-fittings have been bonded onto molded polymeric or composite parts. Such fittings also experience issues with having sufficient strength and also can be vulnerable to corrosive environments that can attack the bonding materials. Further, such bonded structures may not hold up well under cyclic or high variation in load or temperature.

Rivet solutions and other alternative fasteners have been presented as well, but do not have the preferred locking capability of a threaded surface. In addition, in forming such alternative fasteners, many times a post-molded machining operation is needed which can cause cutting of fiber in composite materials leading to reductions in composite strength.

Accordingly, there is a need in the art for an improved composite or polymeric fastener or other component part having intricate features on its surface, such as a threaded surface, which can function comparably to a metallic counterpart yet provide the strength and benefits of a composite or polymeric base material without losing the characteristics of the base material in formation of the component part in the formation process.

### BRIEF SUMMARY OF THE INVENTION

In one embodiment, the invention includes a molded article having a surface feature thereon, wherein the molded article comprises a polymeric composite material having reinforcing fibers in a polymeric matrix material; the surface feature has a depth measured transversely on the molded article of about 0.2 mm to about 20 mm; and the surface feature is created during heat molding of the polymeric composite material to form the article such that the surface feature comprises the polymeric matrix material and the reinforcing fibers.

A portion of the molded article may have a generally circular cross-sectional configuration and the surface feature may be at least one thread capable of coupling the portion of the article to a second article having mating threads. In a preferred embodiment, the depth of the surface feature may be about 0.5 to about 5 mm.

In a further embodiment, the polymeric matrix material may comprise a polyarylene, such as polyether ether ketone, polyether ether ketone ketone, polyether ketone, polyether ketone ketone, polyether ketone ether ketone ketone; a fluoropolymer such as a copolymer of tetrafluoroethylene (TFE) and a perfluoroalkylvinylether (PAVE) (e.g., PFA), a copolymer of perfluoro methylvinylether (PMVE) (e.g., PMA), a copolymer of TFE and a perfluorinated alkylene such as hexafluoroproylene (e.g., FEP), and fluorinated ethylene-propylene copolymers; and alloys, copolymers and blends thereof. The reinforcing fibers may be, for example, glass, carbon, graphite, polyaramid, basalt, quartz, boron, hemp, polybutylene oxide, alumina, silicon carbide, silicon nitride, silicon boride and other organic inorganic metallic and metalized fibers and combinations of such fibers. Preferably, the molded article is molded from a polymeric composite formed as a tape, a fabric, a non-woven mat or a paper like composite preform, having longitudinally extending reinforcing fibers in the polymeric matrix material and more preferably, it is formed by a bladder inflation molding process.

In a further embodiment, among many possible uses of the molded article, the article is a load-bearing rod, such as an actuator rod, tie rod or a shaft, such as a shaft used for rotating equipment, or pressure vessel.

In another embodiment, the invention also includes a molded article formed from a bladder inflation molding process, wherein the molded article is bladder inflation molded from a polymeric composite material formed as a tape having longitudinally extending reinforcing fibers in a polymeric matrix material; and a portion of the molded article has a generally circular cross-sectional configuration, and at least one thread capable of coupling the portion of the article to a second article having mating threads, wherein the at least one thread is created during the bladder inflation molding of the polymeric composite material to form the molded article such that the at least one thread comprises the polymeric matrix material and the reinforcing fibers therein.

In still a further embodiment, the invention includes a composite tubular article having a surface feature thereon, wherein the composite tubular article comprises a polymeric composite material having reinforcing fibers in a polymeric matrix material; the surface feature has a depth measured transversely on the composite tubular article of about 0.2 mm to about 20 mm; and the surface feature is created during heat molding of the polymeric composite material to form the composite tubular article such that the surface feature comprises the polymeric matrix material and the reinforcing fibers therein.

Also within the invention in one embodiment is a method for providing a surface feature to a molded article. The method comprises providing a composite material comprising a polymeric matrix material and longitudinally extending reinforcing fibers therein; placing the composite material in a mold for forming an article having a surface feature thereon; molding the composite material using bladder inflation molding and pushing the reinforcing fibers into the surface feature of the molded article during molding using a heat molding process having a bladder inflation molding step, wherein the surface feature is created during the molding of the polymeric composite material to form the molded article and the reinforcing fibers are present in the matrix material defining the surface feature in the molded article. Molded articles formed by the method may be tubular composite articles and the surface features are preferably at least one thread on a surface of a tubular composite article.

In the various embodiments herein, the reinforcing fibers within the at least one thread are preferably present as threaded patterns formed of oriented reinforcing fibers.

In selecting a composite material for use in the embodiments herein, it is preferred that the content of reinforcing fiber in the composite polymeric matrix material is at least about 30 volume percent, and more preferably a higher loading, such as at least about 40 volume percent, based on the total volume of the composite.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a perspective view of a molded composite article according to one embodiment herein;

FIG. 2 is side elevational view of the molded composite of FIG. 1;

FIG. 3 is a cross-sectional view of the molded composite of FIG. 2 taken along line 3-3;

FIG. 4 is an enlarged portion of a surface feature of the molded composite as shown in FIG. 3; and

FIG. 5 is a magnified photographic representation of a cross-sectional portion of a prior art composite having threads machined on the surface;

FIG. 6 is a magnified photographic representation of a cross-sectional portion of a composite having threads formed according to the Example herein;

FIG. 7 is an enlarged photographic representation of the composite of FIG. 6;

FIG. 8A is a longitudinal cross sectional view of an actuator rod taken along line 8A-8A of an example of an actuator rod having a portion thereof formed as a molded composite article described herein;

FIG. 8B is side elevational view of the actuator rod of FIG. 8A;

FIG. 8C is an enlarged portion of one end of the actuator rod of FIG. 8A;

FIG. 8D is an enlarged portion of the other end of the actuator rod of FIG. 8A; and

FIG. 9 is a flow chart representing steps in a method according to an embodiment described in the disclosure.

### DETAILED DESCRIPTION OF THE INVENTION

The invention will be described with reference to the drawings herein. In the specification, words such as “inner” and “outer,” “upper” and “lower,” “left” and “right,” “inwardly” and “outwardly,” and “upwardly” and “downwardly,” and words of similar import are used for assisting in the understanding of the invention when referring to the drawings and absent a specific definition or meaning otherwise given by the specification for such terms should not be considered limited to the scope of the invention.

The present invention overcomes disadvantages encountered in various prior art molded articles by providing a molded article having small customized features on its surface formed from a composite material having a polymeric matrix material and reinforcing fibers, thereby enabling the end application of the articles to have a reduced weight, while maintaining mechanical properties at comparable or better levels in comparison to traditional metallic parts (or generally improved properties in comparison to machining features using composites). The embodiments herein also avoid the need to machine the article or use other specialty steps to create features on the surface of a molded article. To enhance tolerance tightness of the surface feature, if desired, a post-molding machining operation can be used, however, it is preferred that the post-molding machining removes less than about 30% of the feature volume, and preferably less than about 20% of the surface feature volume and most preferably less than about 10% of the surface feature volume.

In a preferred example described herein for the purpose of illustrating the invention, molded composite articles are described with reference to molded tubular composite articles, such as articles, parts, components, etc. which may be formed having a customized threaded pattern on at least a portion of a surface thereof, wherein the threads are capable of being combined with mating threads on another part for connection of the parts. The features, herein threads, are formed while the tube itself is being molded from a composite having the reinforcing fibers therein so that upon molding, the fibers are present in the features and follow a “wavy” pattern when viewing the material in longitudinal cross-section upon enlarged inspection.

By forming the article in this manner, the resulting tubular composite articles have a load transfer capability given by the pattern which is better than in various prior art attempts to mold composite articles, while producing an article having the features such as a threaded pattern already formed and ready to use such that further modification by machining is optional, for example, as noted above, machining can be used to enhance tolerance tightness. Procedures such as machining, overmolding, outsert molding, insert molding, etc. are not used for initial formation of the feature. Thus the ultimate assembly having such a tubular composite molded part achieves over and above what is expected to be achieved using the same geometrical connections formed by machining threaded patterns on various prior art composite tubes.

The capability to form such structures can have a wide variety of uses and end applications, including but not limited to load-bearing rods, such as actuator rods, tie rods and similar parts, aeronautical parts, aerospace parts, medical parts, train parts, sporting goods, automotive parts, machine parts, pressure vessels, and the like. Such parts can be used in various structures and assemblies including airplanes, machines, engines, furniture, moving parts, assemblies, semiconductor industry parts, oilfield industry parts, power plant industry parts, pumps and compressor parts, frictional wear parts, and the like. In corrosive, high temperature, or other difficult environments and/or in applications where tubular parts need to be connected to other components and achieve good strength and/or anti-corrosive properties, such composite structures also are suitable in end applications that have not been fully satisfied using prior art machined and/or bonded threaded parts. Examples of such end applications include down hole applications or simulations of down hole conditions in a laboratory where such formed threaded composite tubes can act as electro-magnetic windows or electric insulators. Such composites formed according to this disclosure can also be used in compressor cans or other forms of separation layers for magnetically driven systems such as compressors and pumps. Further such components may be used in power transmissions with rotating shafts where the composite tube is used to transfer high or low torque loads at a variety and range of speeds from low to high. The above uses are examples only and not intended to be limiting in any way to the scope of the invention.

In describing molded articles having surface features thereon in the invention it should be understood that while the Detailed Description preferred embodiment being described herein is a tubular composite molded article having surface thread(s) on a surface thereof, other molded articles, tubular, conical, cylindrical and any other non-tubular article, can be formed with various surface features, which may be small, to create articles with more uniform properties and consistent strength and ability to withstand high tensile and/or torsion loads even in the area of the surface features. This is due to the fact that the reinforcing fibers in the composite matrix material stay within the surface features as oriented reinforcing fibers in a pattern that will generally follow the shape or configuration of the surface features. For example, in the threads formed herein, when the reinforcing fibers in the polymeric matrix material are molded, they are pushed into the threaded features during molding so that they begin to form to the desired threaded configuration. They will separate where pushed the furthest away from the surface and/or are compressed where the feature is compressed inwardly. However, they will remain in the oriented pattern. Because there are no additional surface adhesives that may be vulnerable to conditions of use and/or frangible and no machining necessary, there is little or no damage caused to the reinforcing fibers when forming the threads. This leaves a clean, consistent, reinforced surface feature.

Polymeric composite materials suitable for matrix materials include engineering thermoplastics of a variety of types. Preferred thermoplastics for use in the composites herein are preferably polymeric plastics and resins that can be loaded or filled with reinforcement, particularly reinforcing fiber and that can flow under application of heat and pressure. Exemplary thermoplastics include polyolefins (such as polyethylene, polybutylene, polypropylene), poly(acrylonitrile-butadiene-styrene)(ABS), polystyrenes, polybutadiene, polyacrylonitrile (PAN), poly(butadiene-styrene) (PBS), poly(styrene-acrylonitrile) (SAN), polybutylenes, cellulosic resins (such as ethylcellulose, cellulose acetate, cellulose acetate butyrate, cellulose acetate propionate, and cellulose nitrate), polyethylene vinyl alcohols (EVA), polyethylene vinyl acetates, fluoropolymers (such as melt-processible fluoroplastics (such as copolymers of tetrafluoroethylene (TFE) and at least one perfluoroalkylvinyl ether (PAVE) (PFA), copolymers of TFE and at least one other perfluorinated alkylene (such as hexafluoropropylene) (FEP)), poly(chlorotrifluoroethylene), polyethyl chlorotrifluoroethylene (ECTFE), polyethyltrifluoroethylene (ETFE), fluorinated ethylene-propylene copolymers, polyvinyl fluoride (PVF) and polyvinylidene fluoride (PVDF)), ionomers, liquid crystalline polymer (LCP), polyacetals, polyacrylates, polyamides (such as NYLON 12, NYLON 6), polyphthalimides, polyimides, polyetheramides, polyamideimides, polyphenols, polycarbonates, polyesters, polyurethanes, polyvinylchlorides (PVC), polyvinylidene chlorides, polyvinyls, polyphenylene oxides (PPO), polyphenylene ethers, polyphenylene esters, polyphenylene ether esters, polyphenylene sulfides, polysulfones, polymethylpentenes, polyketones, polyarylene (PAE and PAEK) polymers (such as polyether ether ketone (PEEK), polyether ketone (PEK), polyether ketone ketone (PEKK), polyether ether ketone ketone (PEEKK), and polyether ketone ether ketone ketone (PEKEKK)), thermoplastic elastomers (such as ethylene propylene diene monomers (EPDM), ethylenepropylene rubber (EPR) and polyurethane elastomers), polyethylene chlorinates, biscitraconicimides (BCI), bismaleimides (BMI), bismaleimide/triazine/epoxy resins, cyanate esters, cyanate resins, furanic resins, phenolic resins, urea-formaldehyde resins, melamine-formaldehyde resins, phthalocyanine resins, polybenzoxazole resins, acetylene-terminated polyimide resins, silicones, polytriazines, polyalkyds, and xylene resins.

Co-polymers (polymers formed of two or more monomeric species in random or block form, or graft copolymers, any of which may have multiple monomeric components or reactants) of each or any of these thermoplastics either with each other or with other polymeric, monomeric or oligomeric species may also be used, whether known or to be developed. In addition, such thermoplastics, provided they are still useful for forming an article from a composite thereof, may be derivatized and/or include functional groups (whether terminal and/or on the polymer backbone and/or on a side chain), branched and/or straight chain backbone structures, additional locations of unsaturation along the chain or side groups, and the like. Functional groups which may be provided include aryls, ketones, acetylenes, acid groups, hydroxyl, sulfur-containing groups, sulfates, sulfites, mercapto, phosphato, carboxyl, cyano, phosphite, oxygen/ether or esters (also can be incorporated within the chains or side chains), carboxylic acid, nitric, ammonium, amide, amidine, benzamidine, imidizole, and the like.

The selected polymer(s) may also be used in mixtures, blends, alloys or copolymerized with each other or other monomers to form new random, block or graft copolymers. It is also possible for use within the invention to employ thermosetting materials such as certain high-temperature cross-linkable polyimides and polysulfones and thermosetting materials having similar properties to those of thermoplastics. For the purpose of convenience and simplification herein, such materials will be included within broad reference to thermoplastics, since they may be substituted in the present invention in place of the thermoplastic material. While these thermoplastics are preferred, the list should not be considered to be exhaustive, and one skilled in the art would understand based on this disclosure that other thermoplastics could be used in the invention without departing from the scope thereof

Preferred materials from those noted above include engineering plastics such as polysulfones, polyimides, polyamideimides, polyamides, polyphenylene oxides and sulfides, and the polyarylene materials. Preferred polyarylenes include variations and derivatives (having functionalized or copolymerized structures off the primary polymer backbone) as various PAE and PAEK polymers including PEEK, PEEKK, PEK, PEKEKK, PEKK, and alloys copolymers and blends thereof, such as PEEK and specialty polyarylenes, for example, Vitrex® PEEK from Victrex USA, Inc., Conshohocken, Pa. and Ultura™ available from Greene, Tweed & Co., Inc., Kulpsville, Pa. Fluoropolymers such as copolymers of tetrafluoroethylene (TFE) and perfluoroalkylvinyl ether (PAVE)(e.g., Teflon® PFA); TFE and PMVE (Teflon® MFA); TFE and HFP (Teflon® FEP), polyvinylidene fluoride (PVDF) and polytetrafluoroethylene (PTFE) may also be used as preferred materials, provided they are flowable at a processing temperature.

It is preferred that the composite matrix material be provided herein with fiber reinforcement, with longitudinally extending long reinforcing fibers being particularly preferred. Other thermoplastics and/or thermoplastic composites (having the same or different forms of reinforcement or filler) may be used in addition to such reinforcing fiber in the polymeric matrix material. Such additives may be provided to the thermoplastic composite preferably by blending with the thermoplastic matrix material. All of the above materials may include, beyond the preferred material noted herein, various other fillers and/or reinforcing agents. Various additives used as reinforcement include, pigments, dyes, glass, ceramic, mesh, mica, clay, organic colorants, plasticizers, thixotropic agents, flame retardants, UV absorbers, extenders, stabilizers, silicon dioxide, silica, alumina, talc, chopped or short fibers (glass, PTFE, TFE copolymers, carbon, graphite, etc.), barium sulfate, glass spheres, ribbons or platelets, wollastonite, titanate whiskers, compatibilizers, rheological or thixotropic agents, antistatic agents (which may also be incorporated through use of functional groups and/or graft copolymers provided to the thermoplastic matrix), and other similar fillers, tribological additives and other reinforcing agents. It is preferred that such additives (over and above the presence of the composite polymeric matrix material and preferred fiber reinforcement) be present in an amount no greater than about 25%, and preferably no greater than about 10% of the composite by weight based on the total weight of the composite, however, more or less materials may be used depending on desired properties and end uses.

The reinforcing fiber(s) may be a single type of fiber or a combination or blended material, i.e., more than one fiber type may be used within the polymeric matrix material, including for example, without limitation, glass, carbon, graphite, aramid, ceramic, PTFE (available commercially as Teflon®), basalt, quartz, boron, hemp, polybutylene oxide (PBO), alumina, TFE copolymer, glass/carbon, glass/graphite/carbon, graphite/carbon, aramid/glass, ceramic/glass and PTFE or TFE copolymer fiber/carbon blends. Such fibers may be organic or inorganic, including various materials such as noted above and preferably ceramic, glass, graphite, carbon, and/or plastic (thermoplastic and thermoset) fibers (such as aramid fiber, available commercially as Kevlar®) or metallic or metalized fibers such as nickel fibers, or nickel coated carbon fibers. The continuous fibers may be unidirectional or bi-directional continuous fibers, although unidirectional fibers are preferred (if bidirectional, it is preferred that no more than about 50% of the fibers are present in the transversely extending direction), stretch-broken, braided fibers and woven continuous fibers. Additionally, the fibers may be braided or commingled fibers.

Preferred diameters for the long fibers include about 0.1 μm, about 5 μm to about 15 μm, and about 7 μm to about 10 μm. Carbon fiber or carbon fiber blends are preferred for various strength applications. It is preferred that the reinforcing fiber be long, preferably continuous fibers arranged generally longitudinally within the matrix material. More preferably, the composite for use in molding articles herein is in the form of a tape, a fabric, a non-woven mat or a paper like composite preform having fibers arranged generally juxtaposed in longitudinal arrangement within an impregnated or compressed composite tape or similar long structure (rods, pressure vessels, etc.). In fiber blends or combined fibrous reinforcements, additional filler fibers may be provided in addition to the long fiber the form of chopped strands, filaments or whiskers to the fiber matrix as noted above. Further, such blends may include any range of potential woven or blended fibrous materials provided sufficient strength and other desired properties are retained. One skilled in the art will understand based on this disclosure that if such additional fillers, short fibers, strands, etc. negatively impact the properties achieved from the patterned fiber in the surface features such that desired physical or environmental properties, the additional materials should be minimized or avoided.

It is preferred that the long fiber reinforcement is present in a high volume content, with the understanding that how much fiber can be loaded depends on the polymeric matrix material and impregnation process to some extent, and that in forming the composite, one skilled in the art of composite formation would use as high a volume loading as practical while maintaining physical properties, structural integrity and generally uniform properties. Preferably the long fiber longitudinally arranged fibers are present in an amount or content of at least about 30% by volume, more preferably at least about 40% by volume, most preferably at least about 50% or higher volumes of up to about 60% to about 90% by volume based on the total volume of the composite (depending on the loading capacity of the thermoplastic matrix material).

The composite materials used herein can be provided by any continuous long fiber-containing composite structure. In one preferred embodiment herein, a continuous fiber structures such as an impregnated continuous fiber tape, fabric or the like may be used. As used herein, continuous fibers in such structures are those which generally have a length being greater than about 0.5 inches (1.27 cm). Such tapes or other continuous fabric, tape, rod stock and the like may be cut for use in forming the composites, but are preferably formed using molding techniques as discussed herein which maximize retention of the long fiber structures, for example, structures having reinforcing fibers primarily having a length to diameter ratio of greater than about 100:1.

In forming a surface feature, the surface features may include a variety of designs and patterns—grooves, imprinted patterns, receiving recesses for various parts, wells, vias, channels, threads, etc. As discussed herein, in a preferred design, a tubular composite is formed having at least one, and possibly more than one thread as a surface feature on a surface of the tubular composite article when formed.

Surface features can vary in size and include even reasonably small features such as threads which not only are small but require precision in size and configuration to be successfully used in releasably connecting a threaded surface to a mating threaded surface on another article by screwing and/or bonding the two articles together. In FIG. 1, an example of a molded article, generally referred to as molded article 10 is illustrated. The molded article 10 is a tubular composite article 12 having a tubular configuration, generally circular cross section in the end and/or transverse view (see FIG. 2) and a thread 14 formed in a coiled configuration around an outer surface 16 of the tubular composite article 12. The inner surface 18 as shown in the drawings of this embodiment is not threaded, but one skilled in the art would understand that the design could be varied to form other threaded surfaces, namely the inner surface of a tube. A passageway 20 extends through the tubular composite article 12. The composite article 12 also has an end surface 22 which is not shown to have features, however, features could be molded on any surface using the invention herein. As shown, the thread 14 has a repeat pattern on the surface 16 having various inwardly extending areas 24 defined by walls or opposing surfaces 26 of the surface 16. The thread(s) may be formed over the length of a surface of a molded article or over a portion thereof. As shown, tubular composite article 12 has thread 14 formed along a portion 30 of the length of its outer surface 16. Such thread(s) 14 or other features can be placed on an inner or outer surface of a molded article, and in use a thread 14 should be capable of coupling the portion 30 of the molded article having the thread to a second article (which may be the same or different than the article 10 and so is not shown herein and is not limited to any particular overall configuration) having mating threads in a manner known in the art such as by screwing the mating thread together to thread 14.

In forming surface features areas of the surface having the feature may be formed so as to extend outwardly beyond the level of the surface and/or to extend inwardly into the composite article from the level of the surface. A feature has an inwardly extending area (see area 24 for example) measured from the outermost portion of the surface (including any portion of the surface which may extend outwardly) to the innermost portion of the feature (which may be at the surface level if another portion extends outwardly or extending inwardly into the composite article from the level of the surface).

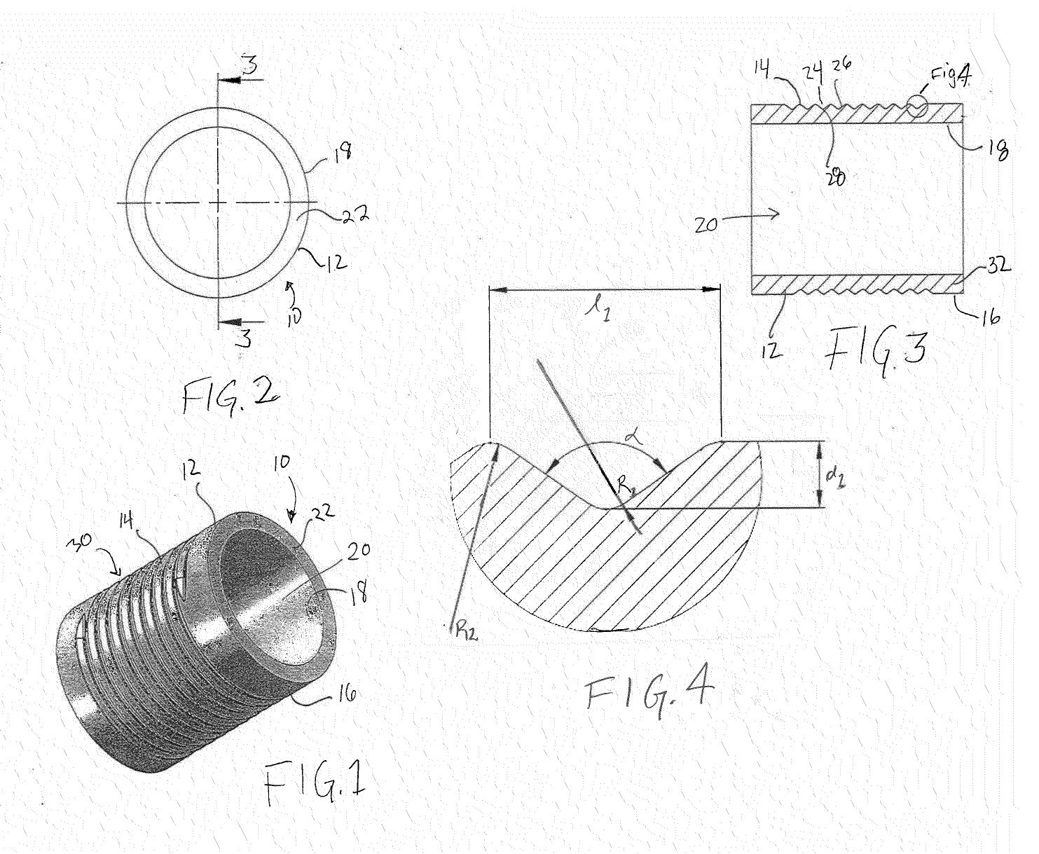

As shown in FIG. 4, a surface feature in the form of a thread has a depth d₁ which measures a length/depth from the height of the thread 14 to the lowest point 28 of the thread in a transverse direction across the feature. The walls or opposing surfaces of a feature may be generally perpendicular to the surface and separated so as to form a “floor” or other surface characteristic therebetween or joined at one end so as to form an angle therebetween. The space between the walls is the area for which the depth d₁ is measured. As shown in FIG. 4, the area 24 is formed by two walls 26 joined at their most inner (lowest) point on the surface 28.

An angle a is formed between the walls 26. In making threads 14 or any other threaded pattern, the length l₁ of the flat portion of the wall, the size of the upper peak or curve (radius r) and the depth d1 can be specified to be very precise and those measurements incorporated into the mold design or a mold insert in an interchangeable mold for forming different threaded surface features, cross-threads, multiple threads on the same article and the like. In addition, the orientation of walls 26 need not be as shown and may vary such that the configuration of the area 24 varies as well as the angle a, leaving different types of surface features. For example, thread(s) can be formed having grooved, channeled, curved, triangular or circular cross sectional shapes formed by walls 26 and the area 24.

In forming a thread feature, d₁ can vary from about 0.2 mm to about 20 mm, more preferably from about 0.5 mm to about 5 mm. The radius/radii, R₁ and R₂, which may be the same or different, is/are preferably about 0.1 mm to about 10 mm, more preferably about 0.25 mm to about 2.5 mm. The angle α is preferably about 10° to about 170°, more preferably about 30° to about 150° and most preferably about 90° to about 130°. The pitch length l₁ measured longitudinally from the top of one thread to the adjacent top of the next thread is automatically defined once d₁, R₁ and R₂, and a are defined. Other measurements for different features may be used and such measurements are examples only, and not intended to be limiting.

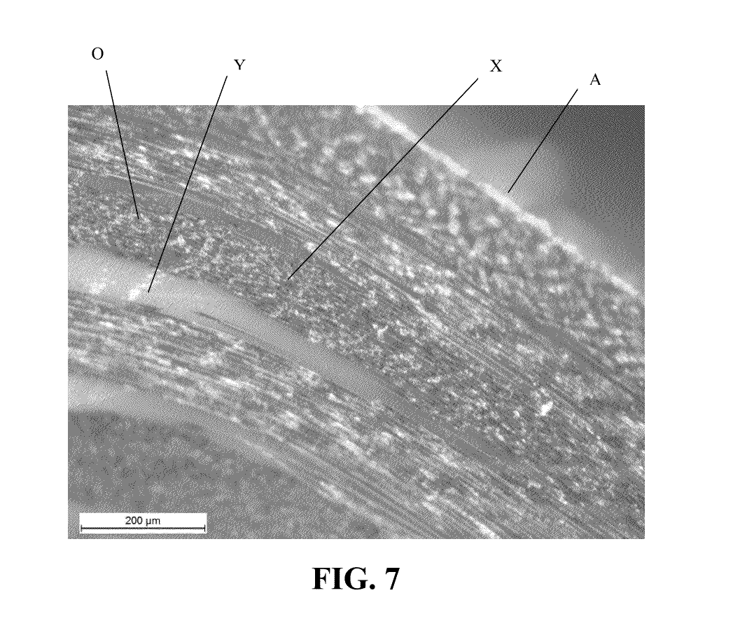

The surface feature(s) are formed during a heat molding step when forming the polymeric composite material into the molded article. As shown in FIG. 3, the composite material 32 extends throughout the molded article 10 in cross-section and should be generally uniform including, but not limited to, at least one polymeric matrix material, preferably long reinforcing fibers. As shown in FIGS. 6 and 7, an exemplary composite thread A is shown in enlarged view formed from a composite X having polymeric matrix material Y and reinforcing fiber O. As shown, the fiber O is a carbon fiber, such as carbon AS4 fiber (commercially available from Hexcel® Corporation, Connecticut) and the matrix material Y is PEEK (commercially available from Victrex® Polymer Solutions, Conshohocken, Pa.). When forming the surface feature(s) during heat molding according to the disclosure, the surface features thus formed will incorporate the reinforcing fibers in the matrix material. The fibers are preferably present in a pattern following generally the longitudinal manner in which they are arranged in the original composite material molded to form the article.

In a particularly preferred embodiment herein, the molded article 10 is formed by a method which incorporates a bladder inflation molding process or step(s) thereof. Bladder inflation molding (BIM), otherwise known as bladder insert molding, techniques are known in the art and are described in publications the relevant portions of the disclosures of which are incorporated herein by reference, including N. D. Weibel et al., Complex Hollow Shapes from Thermoplastic Composites, Proceedings of the 20^{th} International SAMPE Europe Conference, Paris, pp. 129-135 (1999) and N. D. Weibel et al., High Rate Bladder Moulding of Thermoplastic Composite, Proceedings of the 21^{st} International SAMPE Europe Conference, Paris, pp. 317-327 (2000). Such techniques are not limiting and any suitable BIM technique in which an expandable or other bladder is inserted in a mold cavity having a surface for forming the desired molded article so that the bladder forms the inner shape of the cavity in the molded article, for example, the hollow passageway 20 through molded article 10 in FIGS. 1-4.

The bladder can be sized and shaped for a desired end structure. Use of the bladder and force from within the bladder in combination with a composite as described herein having longitudinally extending fiber reinforcement and a mold surface to create the features as desired, places the reinforcing fibers in a pattern structure within the features themselves so that the features are formed without the need for machining or other surface manipulation and less damage is done on the final surface. The finished article surface features retain the desired strength and physical properties of the composite material. Various types of inflatable bladders may be used in the BIM step(s) of the process including a variety of materials including but limited to metals, polymers such as PI, PTFE, Teflon PFA, Teflon MFA, Teflon FEP, PVDA or elastomers such as silicone rubbers, fluoroelastomers (FKM) and perfluoroelastomers (FFKM), and/or any other suitable material.

In the case of a winding thread, the BIM step(s) force the reinforcing fiber by pushing into the pattern of the features of on the mold surface by pushing from the internal bladder so that the fibers are pushed into the helix pattern of the thread as it winds around the tubular composite formed.

The invention includes a molded article such as a tubular composite as described above which is formed from a process having a BIM step(s). The molded articles are preferably formed by the BIM step(s) using a polymeric composite material such as those described in detail above and having longitudinally extending reinforcing fibers within a polymeric matrix material as described herein. A portion such as portion 30 of the molded article 10 may be generally circular in cross-sectional configuration as shown in FIGS. 1-4. At least one thread 14 winds around the surface of the article 10 as a surface feature and is capable of coupling the portion 30 of the article to a second article having mating threads (not shown).

The at least one thread 14 is created during the BIM step(s) wherein the polymeric composite, such as a long fiber-reinforced tape is molded into the molded article 10, preferably a tubular composite 12. In doing so, the at least one thread 14 includes within its matrix the reinforcing fibers. The fibers are preferably present in a pattern as noted above.

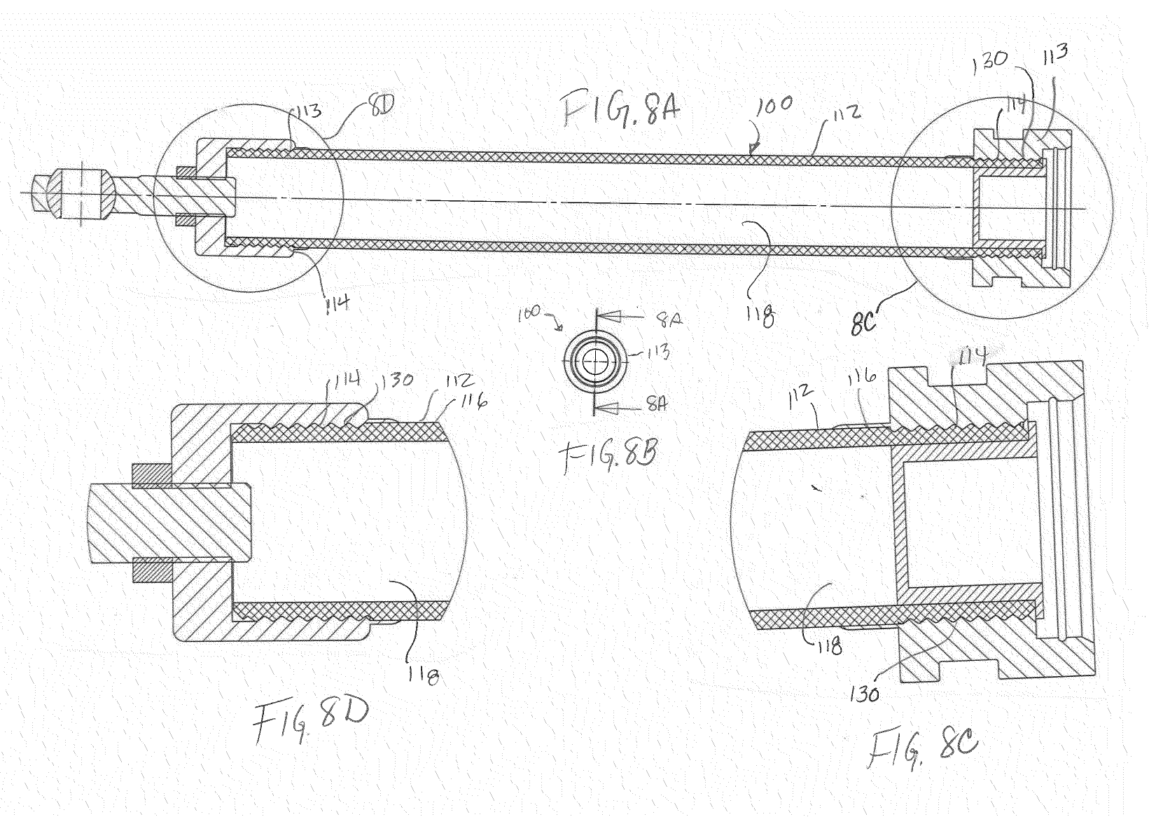

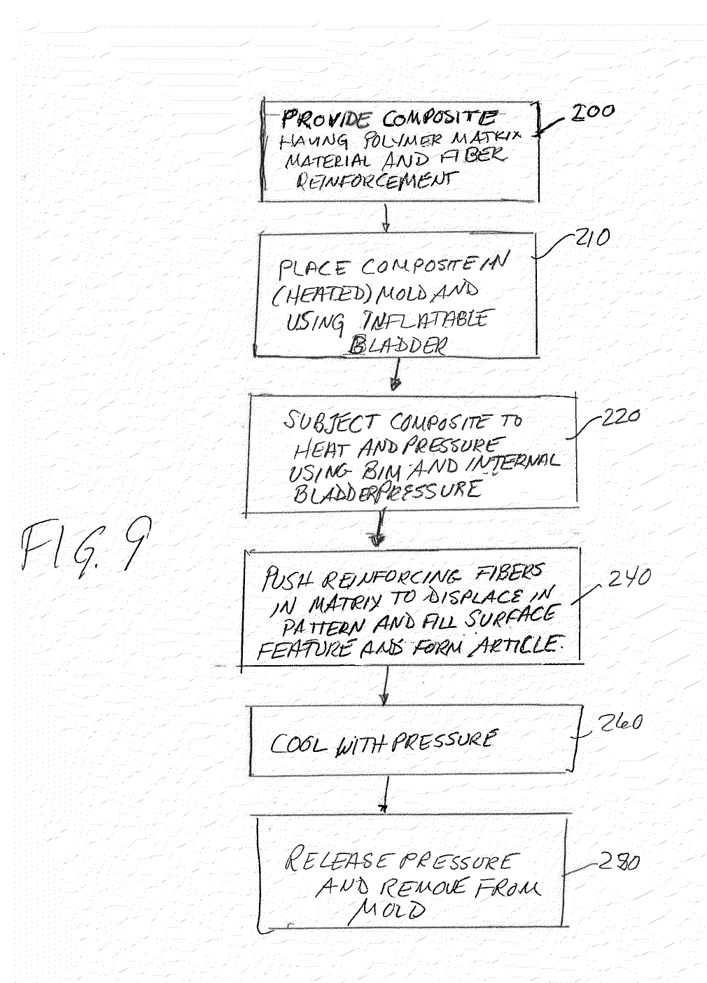

As shown in FIGS. 8A-8D, an example of a molded article 100 in the form of an actuator rod 112 is demonstrated. The actuator rod 112 is a tubular composite forming a portion of the overall structure. The end pieces 113 in this embodiment are formed of metallic fittings. Any suitable metal or composite for use in an actuator rod may be used for end pieces 113 according to structures known in the art. The tubular composite portion 112 is formed of a polymeric composite as described herein having portions 130 of the inner surface 118 and outer surface 116 with surface features in the form of two separate areas of threads 114. The threads are formed by the techniques described herein using BIM step(s) and having as its structure a polymeric composite material as described in detail herein. As shown, metallic end portions 113 are formed, however, it should be understood that the end portions may be made using the invention hereof without departing from the spirit and scope of the invention. If desired, the outer surface 116 or inner surface 118 of the composite molded actuator rod portion 112 once formed may be formed so as to have an optional outer coating (not shown) of metallic or other materials for anti-corrosive, anti-abrasive, impact resistance, sealing capability, or aesthetic reasons, for example, a coating of tungsten carbide-cobalt-chromium (WC/Co—Cr) for a finish. Such coatings may be applied using known techniques or preferably techniques developed and commercially available from Greene, Tweed & Co., Inc. of Kulpsville, Pa., United States.

Also within the disclosure is a method for providing a surface feature to a molded article, such as for providing a thread(s) as a surface feature to a molded article, such as those described herein and shown in FIGS. 1-4 and 8A-8D.

With reference to FIG. 9, the method includes the step 200 of providing a composite material such as the composite materials described above in detail and having a polymeric matrix material and longitudinally extending reinforcing fibers. Such materials are described above in great detail and may be used as is or with various additives as also described herein.

The composite material is placed in a mold in step 210 which is designed to have a surface which can form the exterior surface shape of the molded article including the surface feature to be formed thereon. The mold may be any suitable mold either pre-formed in the exterior shape of the article or having a block for inserting various mold forms for heat molding articles. In forming the composite, it is preferred that the interior be shaped by an interior bladder which is inserted in the mold and is preferably inflatable, i.e., using BIM step(s) 220. The composite material is then molded using such BIM step(s) so that the reinforcing fibers are pushed by the bladder 240 to be included within that portion of the polymeric composite material that forms the surface feature of the molded article during the molding and when subject to a heat process including the BIM molding step(s). The surface feature is thus created during the molding of the polymeric composite material to form the molded article and the reinforcing fibers are present in the matrix material defining the surface feature in the molded article.

The molded article is preferably a tubular composite article as described herein with at least one thread on a surface of the tubular composite article, such as a load-bearing rod, including shafts, tie rods, actuator rods and the like as discussed above. The BIM step(s) 220, 240 are preferably used so that the reinforcing fibers within the at least one thread are present as threaded patterns formed of oriented reinforcing fibers.

The molding conditions, both time and temperature, as well as bladder inflation pressure, will vary depending on the molding materials used and the type of structure to be formed. Preferably, the mold is heated to temperatures of about 100° C. to about 500° C. for most thermoplastic polymeric matrix materials, more preferably about 200° C. to about 500° C. Depending on the materials used, e.g., if using polyarylenes, preferred temperatures are about 300° C. to about 500° C., and more preferably to about 360° C. to about 400° C. When processing the material, the temperature is preferably maintained at about 100° C. to about 450° C., preferably about 200° C. to about 400° C. For polyarylenes, processing temperatures are preferably about 360° C. to about 390° C.

Mold pressure within a bladder pressing the composite material against the surface feature may vary from about 1 bar to about 2,000 bar. The pressure is more preferably about 10 bar to about 40 bar. After molding, and preferably before releasing the pressure on the bladder within the mold, the mold is optionally cooled 260 using either cooling water configured to be circulated within the mold block, or by placing in a cooling block. After cooling under pressure within the mold or cooling block, preferably at internal bladder pressures of about 1 bar to about 2,000 bar, and more preferably of about 10 bar to about 40 bar, to complete the process, in step 280, the pressure within the bladder can be released gradually and the composite part having surface features thereon may be removed from the mold cavity. Additional optional steps, such as applying coatings (not shown), additional mating parts (not shown), finishing steps and the like may still be provided after the article is formed as noted above, but are not required.

The invention will now be described with respect to the following non-limiting Example.

### EXAMPLE

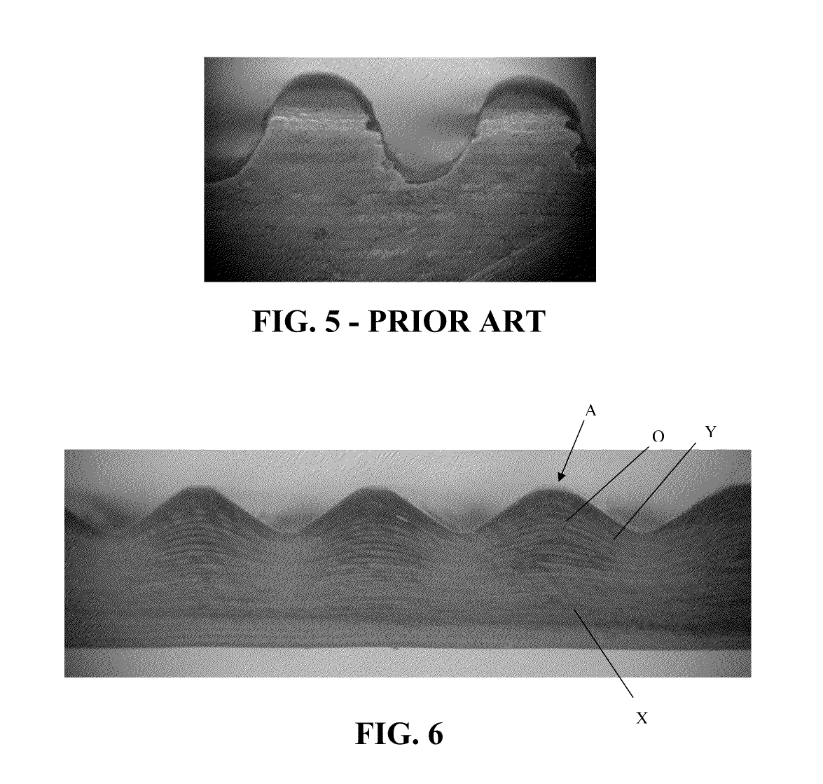

A fiber reinforced PEEK/carbon fiber composite material was prepared into the form of a tape having PEEK (commercially available under the name PEEK G150 from Victrex® Polymer Solutions) and AS4 carbon fiber (commercially available from Hexcel® Corporation). The tape was continuous in length and about 300 mm in width at a thickness of about 0.13 mm. The PEEK/carbon fiber composite was formed into a tubular shape and a thread pattern was machined into an outer surface thereof according to a prior art method. The threaded pattern was a DIN 405 and the tube had an external diameter of 50 mm and a wall thickness of 4 mm. The resulting article was a 50 mm diameter tubular composite article having a wall thickness of 4 mm and having a machined thread covering a 30 mm length on both ends of the tube. The internal structure is shown in FIG. 5 in an enlarged photographic view taken with a Leica MZ 6. Inspection of the thread cross-section shows how fibers have been cut to obtain the threaded pattern.

The same composite material was molded into a composite article formed as a tubular composite, but having a thread as an outer feature on the exterior surface thereof using BIM molding. A mold having a cavity with an inner surface capable of forming the thread thereon was used along with an inflatable bladder inserted therein. The resulting composite tube was a 50 mm diameter tube having a 4 mm wall thickness and a molded thread covering a 30 mm length on both ends of the tube. As shown in photographic views FIGS. 6 and 7, the thread surfaces are smooth and the reinforcing fibers appear in a pattern and are generally longitudinally extending but following the pattern as shown.

The prior art tube of FIG. 5 and the tubular composite formed according to the invention of FIGS. 6 and 7 were each tested in tension. The prior art tube failed under a tensile force of 57 kN. The molded threads according to the disclosure herein did not fail until a tensile force of 156 kN. The Example demonstrates that the molded thread composite article is capable of withstanding a significantly higher tensile and/or torsion load on the molded article.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A molded article having a surface feature thereon,
wherein the molded article comprises a polymeric composite material having reinforcing fibers in a polymeric matrix material;
the surface feature has a depth measured transversely on the molded article of about 0.2 to about 20 mm; and
the surface feature is created during heat molding of the polymeric composite material to form the article such that the surface feature comprises the polymeric matrix material and the reinforcing fibers of therein.

2. The molded article according to claim 1, wherein a portion of the molded article has a generally circular cross-sectional configuration and the surface feature is at least one thread capable of coupling the portion of the article to a second article having mating threads.

3. The molded article according to claim 1, wherein the depth of the surface feature is about 0.5 to about 5 mm.

4. The molded article according to claim 3, wherein a portion of the molded article has a generally circular cross-sectional configuration, the surface feature is at least one thread capable of coupling the portion of the article to a second article having mating threads and a transverse depth of the surface feature is about 0.5 to about 5 mm.

5. The molded article according to claim 1, wherein the polymeric matrix material comprises is a thermoplastic.

6. The molded article according to claim 5, wherein the polymeric matrix material comprises a polyarylene polymer or copolymer.

7. The molded article according to claim 6, wherein the polymeric matrix material comprises a thermoplastic selected from the group of polyether ether ketone, polyether ketone, polyether ether ketone ketone, polyether ketone ether ketone ketone, polyether ketone ketone, and alloys, copolymers, cross-linked polyarylene polymers and copolymers and/or blends thereof.

8. The molded article according to claim 5, wherein the polymeric matrix material comprises a thermoplastic selected from the group of polyphenylene sulfides, polyetherimides, polyether sulfones, moldable thermoplastic fluoropolymers, and alloys, copolymers, cross-lined polymers and copolymers and/or blends thereof.

9. The molded article according to claim 1, wherein the reinforcing fibers are selected from glass, carbon, graphite, polyaramid, basalt, quartz, boron, chamfer, hemp, polybutylene oxide, alumina, silicon carbide, silicon nitride, silicon boride, metallic or metalized and combinations thereof.

10. The molded article according to claim 1, wherein the molded article is molded from a polymeric composite formed as a tape, a fabric, a non-woven mat or a paper like preform having longitudinally extending reinforcing fibers in the polymeric matrix material.

11. The molded article according to claim 10, wherein the molded article is formed by a bladder inflation molding process.

12. The molded article according to claim 11, wherein the reinforcing fibers within the at least one thread are present as threaded patterns formed of oriented reinforcing fibers.

13. The molded article according to claim 10, wherein the composite material comprises a content of reinforcing fiber of at least about 30 volume percent.

14. The method according to claim 13, wherein the content of reinforcing fiber is at least about 40 volume percent.

15. The molded article according to claim 1, wherein the article is a load-bearing rod.

16. The molded article according to claim 15, wherein the load-bearing rod is an actuator rod, a tie rod, or a shaft for rotating equipment.

17. The molded article according to claim 15, wherein the article is a pressure vessel with removable closing ends.

18. A molded article formed from a bladder inflation molding process,
wherein the molded article is bladder inflation molded from a polymeric composite material formed as a tape, a fabric, a non-woven mat or a paper like composite preform having longitudinally extending reinforcing fibers in a polymeric matrix material; and
a portion of the molded article has a generally circular cross-sectional configuration, and at least one thread capable of coupling the portion of the article to a second article having mating threads, wherein the at least one thread is created during the bladder inflation molding of the polymeric composite material to form the molded article such that the at least one thread comprises the polymeric matrix materials and the reinforcing fibers therein.

19. The molded article according to claim 18, wherein a transverse depth of the surface feature is about 0.2 to about 20 mm.

20. The molded article according to claim 18, wherein the polymeric matrix material comprises a polyarylene polymer or copolymer.

21. The molded article according to claim 20, wherein the polymeric matrix material comprises a thermoplastic selected from the group of polyether ether ketone, polyether ketone, polyether ether ketone ketone, polyether ketone ether ketone ketone, polyether ketone ketone, and alloys, copolymers, cross-linked polyarylene polymers and copolymers and/or blends thereof.

22. The molded article according to claim 18, wherein the polymeric matrix material comprises a thermoplastic selected from the group of polyphenylene sulfides, polyetherimides, polyether sulfones, moldable thermoplastic fluoropolymers, and alloys, copolymers, cross-lined polymers and copolymers and/or blends thereof.

23. The molded article according to claim 18, wherein the reinforcing fibers are selected from glass, carbon, graphite, polyaramid, basalt, quartz, boron, chamfer, hemp, polybutylene oxide, alumina, silicon carbide, silicon nitride, silicon boride, metallic or metalized and combinations thereof.

24. The molded article according to claim 18, wherein the reinforcing fibers within the at least one thread are present as threaded patterns formed of oriented reinforcing fibers.

25. The molded article according to claim 18, wherein the content of reinforcing fiber is at least about 40 volume percent.

26. The molded article according to claim 18, wherein the article is a load-bearing tube.

27. The molded article according to claim 26, wherein the load-bearing tube is an actuator rod.

28. The molded article according to claim 26, wherein the load-bearing tube is a part of a pressure vessel

29. A composite tubular article having a surface feature thereon,
wherein the composite tubular article comprises a polymeric composite material having reinforcing fibers in a polymeric matrix material;
the surface feature has a depth measured transversely on the composite tubular article of about 0.2 to about 20 mm; and
the surface feature is created during heat molding of the polymeric composite material to form the composite tubular article such that the surface feature comprises the polymeric matrix material and the reinforcing fibers therein.

30. The composite tubular article according to claim 29, wherein the composite tubular article is formed from a polymeric composite material formed as a tape, a fabric, a non-woven mat or a paper like composite preform.

31. The composite tubular article according to claim 29, wherein the composite tubular article is formed using bladder inflation molding.

32. The composite tubular article according to claim 29, wherein the article is a load-bearing tube.

33. The composite tubular article according to claim 32, wherein the load-bearing tube is an actuator rod, a tie rod, a shaft for rotating equipment or part of a pressure vessel.

34. The composite tubular article according to claim 29, wherein the surface feature is at least one thread on at least a portion of the composite tubular article, the at least one thread being capable of coupling the portion of the composite tubular article to a second article having mating threads, wherein the at least one thread is created during the bladder inflation molding of the polymeric composite material to form the composite tubular article such that the at least one thread comprises the reinforcing fibers present as threaded patterns formed of oriented reinforcing fibers and wherein the polymeric matrix material comprises a content of reinforcing fiber of at least about 40 volume percent.

35. The molded article according to claim 29, wherein the polymeric matrix material comprises a thermoplastic selected from the group of polyether ether ketone, polyether ketone, polyether ether ketone ketone, polyether ketone ether ketone ketone, polyether ketone ketone, and alloys, copolymers, cross-linked polyarylene polymers and copolymers and/or blends thereof.

36. The molded article according to claim 29, wherein the polymeric matrix material comprises a thermoplastic selected from the group of polyphenylene sulfides, polyetherimides, polyether sulfones, moldable thermoplastic fluoropolymers, and alloys, copolymers, cross-lined polymers and copolymers and/or blends thereof.

37. The composite tubular article according to claim 29, wherein the reinforcing fibers are selected from glass, carbon, graphite, polyaramid, basalt, quartz, boron, chamfer, hemp, polybutylene oxide, alumina, and combinations thereof.

38. A method for providing a surface feature to a molded article, comprising
providing a composite material comprising a polymeric matrix material and longitudinally extending reinforcing fibers therein;
placing the composite material in a mold for forming an article having a surface feature thereon; and
molding the composite material using bladder inflation molding and pushing the reinforcing fibers into the surface feature of the molded article during molding using a heat molding process having a bladder inflation molding step, wherein the surface feature is created during the molding of the polymeric composite material to form the molded article and the reinforcing fibers are present in the polymeric matrix material defining the surface feature in the molded article.

39. The method according to claim 38, wherein the molded article is a tubular composite article and the surface feature is at least one thread on a surface of the tubular composite article.

40. The method according to claim 39, wherein the reinforcing fibers within the at least one thread is present as a threaded pattern formed of oriented reinforcing fibers.

41. The method according to claim 38, wherein the composite material comprises a content of reinforcing fiber of at least about 30 volume percent.

42. The method according to claim 41, wherein the content of reinforcing fiber is at least about 40 volume percent.
